(19) United States
(12) Patent Application Publication
(10) Pub. No.: US 2008/0043046 A1
(43) Pub. Date: Feb. 21, 2008

(54) Flat panel display and method for driving the same

(75) Inventors: Young Jun Hong, Daegu (KR); Sujin Baek, Geoje-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/652,045

(22) Filed: Jan. 11, 2007

(30) Foreign Application Priority Data
Aug. 16, 2006 (KR) 10-2006-0077009

(51) Int. Cl. G09G 5/10

(52) U.S. Cl. 345/691

(57) ABSTRACT

A flat panel display and method for driving the same are disclosed. The flat panel display comprises a display unit, a scan driver, and a data driver. The display unit comprises sub-pixels disposed at an area where scan lines and data lines cross one another in a matrix form. The scan driver supplies a scan signal to sub-pixels of the display unit through the scan lines. The data driver supplies a data signal and compensation signals to the sub-pixels of the display unit through the data lines, where the compensation signals have different magnitudes according to a length of a path of supplying a scan signal to the sub-pixels.

### CROSS-REFERENCE

This application claims priority to and the benefit of Korea Patent Application No. 10-2006-0077009, filed on Aug. 16, 2006, the entire content of which is incorporated herein by reference.

### BACKGROUND

1. Field

The present invention relates to a flat panel display and method for driving the same.

2. Related Art

Flat panel displays are noted as substitutes for cathode ray tube displays because of their light weight, thin structure, and better image quality. Examples of the flat panel display include liquid crystal displays (LCD) and organic light emitting displays (OLED). As compared with the LCD, the OLED has superior brightness and viewing angle and does not require a backlight, which gives the OLED an advantage in realizing a thin display.

Organic light emitting displays are classified into a top-emission type, a bottom-emission type, and a dual-emission type according to a direction of emitting light. The organic light emitting displays are also classified into a passive matrix type and an active matrix type according to the driving method thereof.

A conventional organic light emitting display comprises a plurality of sub-pixels each comprising two electrodes and an emission layer 116 interposed between the two electrodes. Each of sub-pixels is connected to a data line and a scan line to supply a data signal and a scan signal, respectively. The scan lines 130A and 130B, and the data lines 140 transfer an electric signal from a driver 150 to sub-pixels.

In the organic light emitting display, the length of a path of supplying an electric signal to a sub-pixel differs according to the location of the sub-pixel. Since the length of a path of supplying an electric signal to a sub-pixel differs according to the location of the sub-pixel, the resistance of lines connected to each sub-pixel differs too.

Therefore, the longer the path of supplying an electric signal to a sub-pixel, the more the magnitude of an electric signal is reduced.

It generates luminance deviation like as a moire pattern on a display unit when an image is displayed thereon, thereby degrading the image quality thereof.

### SUMMARY

Accordingly, the present invention provides a flat panel display and method for driving the same with improved the image quality.

In accordance with an aspect of the present invention, there is provided a flat panel display comprising a display unit, a scan driver, and a data driver. The display unit comprises sub-pixels disposed at an area where scan lines and data lines cross one another in a matrix form. The scan driver supplies a scan signal to sub-pixels of the display unit through the scan lines, and the data driver for supplying a data signal and compensation signals to the sub-pixels of the display unit through the data lines, where the compensation signals have different magnitudes according to a length of a path of supplying a scan signal to each sub-pixel.

Each scan line may have different resistance according to the length of a path of supplying each scan signal.

The magnitude of a compensation signal supplied to a sub-pixel having a short path of receiving the scan signal may be smaller than that of a compensation signal supplied to a sub-pixel having a long path of receiving the scan signal.

The length of the path of supplying the scan signal may be from a scan driver to each sub-pixel.

The magnitude of the compensation signal supplied to sub-pixels arranged at the same row may gradually increase or decrease.

The compensation signal may be modulated through one of pulse width modulation and pulse amplitude modulation.

The compensation signal may be supplied in a scan period where the scan signal is supplied.

The scan period may comprise a pre-charge period, a display period, and a discharge period, and the compensation signal is supplied at the display period.

The scan period may comprise a pre-charge period, a display period, and a discharge period, and the compensation signal is supplied at the pre-charge period.

The scan lines comprise even scan lines and odd number lines, the even scan lines may be disposed at one side of the sub-pixels, and the odd scan lines may be disposed at an opposite side of the sub-pixels from the even scan line disposed side.

The even scan lines may be connected to sub-pixels arranged at even row, and the odd scan lines are connected to odd row.

The scan signals may be alternatively supplied to the sub-pixels through even scan lines or odd scan lines.

The sub-pixel may comprise an emission layer interposed between two electrodes.

### BRIEF DESCRIPTION OF THE DRAWINGS

FIG. 1 is a plan view of an organic light emitting display according to an embodiment of the present invention.

FIG. 2 is a schematic circuit diagram illustrating a driver and a display unit according to an embodiment of the present invention.

FIG. 3 is a timing diagram illustrating a method of driving a flat panel display according to an exemplary embodiment of the present invention.

### DETAILED DESCRIPTION OF AN EMBODIMENTS

An embodiment of the present invention will be described with reference to the accompanying drawings. However, the present invention is not limited to an embodiment described below, but may be embodied in a variety of forms. In the drawings, if it is mentioned that a layer is positioned on a different layer or a substrate, the layer may be formed directly on the different layer or the substrate, or another layer may be interposed there between. Like reference numerals designate like elements.

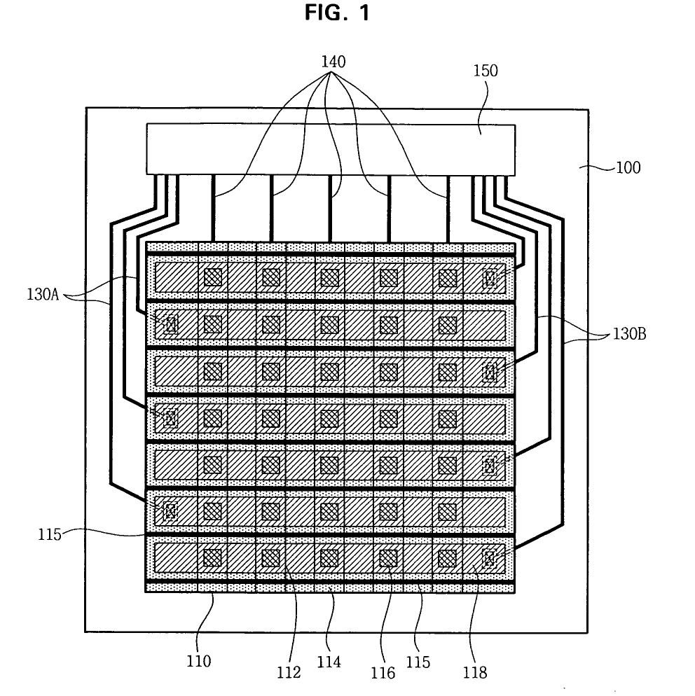

FIG. 1 is a plane view of an organic light emitting display according to an embodiment of the present invention.

Referring to FIG. 1, the organic light emitting display according to an embodiment comprises a display unit 110 disposed on a substrate 100. The display unit 110 comprises an anode 112 patterned in vertical stripes, an insulating layer 114 disposed on the anode 112 and comprising an opening exposing the predetermined part of the anode 112, an emission layer 116 disposed inside the opening, and a cathode 118 disposed on the emission layer 116.

The anode 112 comprises transparent a conductive material such as Indium Tin Oxide having a large work function, and the emission layer 116 may comprise an organic material. The cathode 118 may comprise a metal having a small work function, for example, aluminum or magnesium.

Inverse taper shaped barrier ribs 115 may be disposed on the insulating layer 114. The barrier ribs 115 may be formed to be separated from each other in a direction of crossing the anode 112, and the cathode 118 is patterned by the barrier ribs 115 in a horizontal direction.

The display unit 110 is connected to scan lines 130A and 130B and data lines 140 in order to receive an electric signal from the driver 150. One ends of the scan lines 130A and 130B are connected to one side of the cathode 118, and the other ends of the scan lines 130A and 130B are connected to the driver 150. One ends of the data lines 140 are connected to one side of the anode 112, and the other ends of the data lines 140 are connected to the driver 150.

The scan lines 130A and 130B are classified into even scan lines 130A and odd scan lines 130B. The even scan lines 130A are disposed at one side of the display unit 110, and the odd scan lines 130B are disposed at the opposite side of the display unit 110 from the even scan line disposed side.

Although the scan lines 130A and 130B are disposed at the right side and the left side of the display unit 110 to minimize a dead space in the present embodiment, the present invention is not limited thereby.

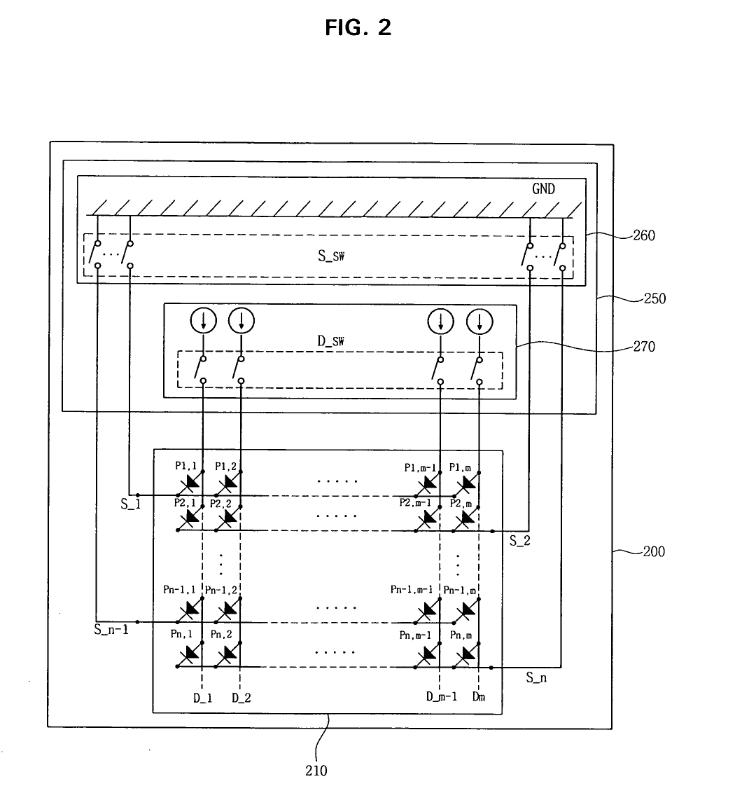

FIG. 2 is a circuit diagram illustrating an organic light emitting display according to an embodiment of the present invention.

Referring to FIG. 2, a display unit 210 is disposed on an area of a substrate 200 where scan lines S-1 to S_n and data lines D_1 to D_m cross one another. The display unit 210 comprises sub-pixels P1,1 to Pn,m each comprising a organic light emitting diode.

The sub-pixels P1,1 to Pn,m are disposed in a matrix type format. The Sub-pixels Pn,1 to Pn,m arranged at one row are connected to one scan line. Scan lines connected to sub-pixels arranged at even rows, that is, even scan lines, are disposed at the right side of the display unit 210, and scan lines connected to sub-pixels arranged at odd rows, that is, odd scan lines, are disposed at the left side of the display unit 210.

The driver 250 may comprise a scan driver 260, a data driver 270, and a control unit (not shown). The scan lines S_1 to S_n and the data lines D_1 to D_m are connected to the scan driver 260 and the data driver 270, respectively.

The scan driver 260 comprises a scan switch S_sw for selectively supplying a signal to the scan lines S_1 to S_n, and supplies a scan signal to the sub-pixels P1,1 to Pn,m of the display unit 210 through the scan lines S_1 to S_n in response to a control signal of a controller.

The scan lines S_1 to S_n are classified into odd scan lines S_odd and even scan lines S_even. The odd scan lines S_odd may be disposed at one side of the display unit 210, and the even scan lines S_even may be disposed at the opposite side therefrom.

The odd scan lines S_odd are connected to the sub-pixels disposed at odd rows, and the even scan lines S_even are connected to sub-pixels disposed at even rows. The scan signals are supplied alternatively to the sub-pixels P1,1 to Pn, m through odd scan lines S_odd or even scan lines S_even.

The data driver 270 comprises a data switch D_sw for selectively supplying a signal to the data lines D_1 to D_m, and supplies a data signal and a compensation signal to the sub-pixels P1,1 to Pn,m of the display unit 210 in response to a control signal of a controller through the data lines D_1 to D_m.

The compensation signal is a signal for compensating the luminance deviation generated according to the length of a path supplying a scan signal to a corresponding sub-pixel.

The lengths of data lines, which are paths of supplying a data signal to sub-pixels disposed at the same row, are same. Therefore, even if the luminance deviation is generated among sub-pixels disposed at the same column, the deviation is about equal.

The lengths of scan lines, which are paths of supplying a scan signal to sub-pixels, however, differ according to a row of a corresponding sub-pixel. The lengths of paths of supplying a scan signal to sub-pixels differ although the sub-pixels are disposed at the same row.

For example, the n^{th} scan line S_n is longer than the first scan line S_1, and a path of supplying a scan signal to a sub-pixel P1n disposed at the n^{th} column among sub-pixels connected to the first scan line is longer than a path of supplying a scan signal to a sub-pixel P11 disposed at the first column.

Since resistance changes according to the length of a path of supplying a scan signal to a corresponding sub-pixel, the magnitude of a scan signal supplied to the sub-pixel becomes changed too.

Therefore, the compensation signal is supplied to each pixel through the data line in order to reduce luminance deviation in consideration of that the length of a path of supplying a scan signal to a sub-pixel differs according to the location of a corresponding sub-pixel.

The length of a path of supplying a scan signal may be from a scan driver 260 to each sub-pixel D1 to Dn.

The magnitude of a compensation signal to be supplied to each of the sub-pixels disposed at a longer path of supplying a scan signal may be greater than that of a compensation signal to be supplied to sub-pixels arranged at a shorter path of supplying a scan signal. Although sub-pixels are disposed at the same column, the magnitude of a compensation signal differs if the row of a sub-pixel differs.

The magnitudes of compensation signals to be supplied to sub-pixels Pn,1 to Pn,m disposed at the same row may gradually increase or decrease. That is, a path of supplying a scan signal to a sub-pixel Pn,m disposed at the m^{th} column among sub-pixels disposed at the n^{th} row is shortest, and a path for supplying a scan signal to a sub-pixel P1,n disposed at the first column is the longest. Therefore, the magnitudes of the compensation signals supplying to the first to the n^{th} sub-pixels Pn,1 to Pn,m become gradually decreased.

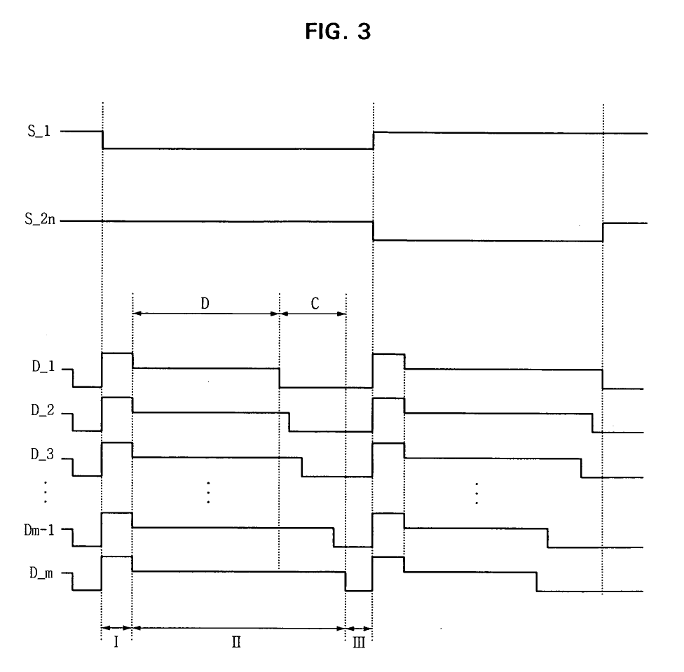

FIG. 3 is a timing diagram illustrating a method of driving a flat panel display according to an embodiment of the present invention. As an example of the method of driving a flat panel display according to the present embodiment, a driving method using a pulse width modulation will be described.

Referring to FIG. 2 and FIG. 3, the scan driver 260 supplies a scan signal to sub-pixels P1,1 to P1,m disposed at the first row through the first scan line S_1 in response to a control signal of a controller.

The data driver 270 supplies a data signal and a compensation signal in response to a control signal of a controller. The data driver 270 may supply a pre-charge signal and/or a discharge signal beside a data signal and a compensation signal.

Since a parasitic capacitance is present at each sub-pixel, it is difficult to accurately express gray scale when a data signal inputs. Therefore, the data driver 270 may supply a pre-charge signal for charging a sub-pixel before supplying a data signal, and supply a discharge signal that discharging a sub-pixel after supplying a data signal.

Accordingly, a scan period where a scan signal is activated comprises a pre-charge period I, a display period II, and a discharge period III. The data driver 270 supplies a data signal and compensation signals with different magnitudes according to the location of corresponding sub-pixels. That is, the display period II comprises a data period D and a compensation period C.

The data driver 270 may supply a data signal and a compensation signal to sub-pixels through data lines by turning on switches connected to data lines, and the magnitudes of the data signal and the compensation signal may be controlled by controlling a time of turning on each of the switches.

The magnitude of the compensation signal may be converted to a time for supplying a compensation signal. Therefore, a time of supplying a compensation signal to sub-pixels connected to the first scan line gradually lengthens in the right direction. Therefore, the displaying time of sub-pixels becomes longer by the data signal and the compensation signal.

On the contrary, a time of supplying a compensation signal supplied to sub-pixels connected to the n^{th} scan line becomes gradually reduced in the right direction.

The magnitude of a compensation signal supplied to a sub-pixel connected to the first scan line and disposed at the first column is greater than that of a compensation signal supplied to a sub-pixel connected to the n^{th} scan line and disposed at the n^{th} column.

For example, it assumes that a compensation signal is formed by pulse width modulation, and a flat panel display has specifications of 160×128, 120 Hz and 140 cd/m2.

It also assumes that a luminance deviation between a sub-pixel having the lowest line resistance and a sub-pixel having the highest line resistance is about 10%. Then, the flat panel display may be driven as follows.

If a compensation period is set to about 3.5 us and each step of a compensation time is set to about 0.125 us with a main clock at 8 MHz, 160, it is possible to control a sub-pixel as 28 blocks, where 1 block is about 5 to 6 sub-pixels.

Although a compensation signal is formed by modulating a pulse width in the present embodiment, the compensation signal may be formed by modulating pulse magnitude. Also, the compensation signal may be formed by modulating the width and magnitude of pulse. In case of modulating the magnitude of the pulse, the compensation signal may be supplied to the pre-charge period, and the magnitude of the pre-charge signal and the data signal may increase.

The flat panel display according to an embodiment of the present invention may reduce luminance deviation between sub-pixels by supplying a compensation signal to each sub-pixel according to a length of a path of supplying a scan signal to a corresponding sub-pixel, thereby improving the quality thereof.

Although the present invention has been described with reference to certain exemplary embodiments, it will be understood by those skilled in the art that a variety of modifications and variations may be made to the present invention without departing from the spirit or scope of the present invention defined in the appended claims, and their equivalents.

What is claimed is:

1. A flat panel display comprising:
a display unit comprising a plurality of sub-pixels located at the intersections of a plurality of scan lines and data lines in matrix type format;
a scan driver for supplying a scan signal to sub-pixels of the display unit through the scan lines; and
a data driver for supplying a data signal and compensation signals to the sub-pixels of the display unit through the data lines, wherein the magnitude of the compensation signals is modulated depending on a length of a path of supplying a scan signal to the sub-pixels.

2. The flat panel display of claim 1, wherein each scan line has different resistance depending on the length of a path of supplying the scan signal to each sub-pixel.

3. The flat panel display of claim 2, wherein a magnitude of a compensation signal supplied to a sub-pixel having a short path of receiving the scan signal is smaller than a magnitude of a compensation signal supplied to a sub-pixel having a long path of receiving the scan signal.

4. The flat panel display of claim 2, wherein the length of the path of supplying the scan signal to the sub-pixel is from a scan driver to each sub-pixel.

5. The flat panel display of claim 1, wherein the magnitude of the compensation signal supplied to sub-pixels arranged at the same row gradually increases or decreases.

6. The flat panel display of claim 4, wherein the compensation signal is modulated by pulse width modulation and/or pulse amplitude modulation.

7. The flat panel display of claim 1, wherein the compensation signal is supplied in a scan period where the scan signal is activated.

8. The flat panel display of claim 7, wherein the scan period comprises a pre-charge period, a display period, and a discharge period, and the compensation signal is supplied during the display period.

9. The flat panel display of claim 7, wherein the scan period comprises a pre-charge period, a display period, and a discharge period, and the compensation signal is supplied from the pre-charge period.

10. The flat panel display of claim 1, wherein the scan lines comprise even scan lines and odd number lines, the even scan lines are disposed at one side of the sub-pixels, and the odd scan lines are disposed at an opposite side of the sub-pixels from the even scan line disposed side.

11. The flat panel display of claim 10, wherein the even scan lines are connected to sub-pixels arranged at even row, and the odd scan lines are connected to odd row.

12. The flat panel display of claim 11, wherein the scan signals alternatively supplied to the sub-pixels through even scan lines or odd scan lines.

13. The flat panel display of claim 1, wherein the sub-pixel comprises an emission layer interposed between two electrodes.

14. A method of driving a flat pane display comprising:
supplying a scan signal from a scan driver to a display unit comprising a plurality of sub-pixels located at the intersections of a plurality of scan lines and data lines in matrix type format; and
supplying a data signal and compensation signals to the sub-pixels from the data driver, where the compensation signals have different magnitudes according to the length of a path supplying a scan signal to a corresponding sub-pixel.

15. The method of claim 14, wherein a magnitude of a compensation signal supplied to a sub-pixel having a short path of supplying the scan signal is smaller than a magnitude of a compensation signal supplied to sub-pixel having a long path of supplying the scan signal.

16. The method of claim 14, wherein the length of a path supplying the scan signal is form the scan driver to each sub-pixel.

17. The method of claim 14, wherein the magnitude of a compensation signal supplying to sub-pixels arranged at the same column gradually increases or decreases.

18. The method of claim 14, wherein the compensation signal is modulated by one of pulse width modulation and pulse amplitude modulation.

19. The method of claim 14, wherein the compensation signal is supplied in a scan period where the scan signal is supplied.

20. The method of claim 19, wherein the scan period comprises a pre-charge period, a display period, and a discharge period, and the compensation signal is supplied at the display period.

21. The method of claim 19, wherein the scan period comprises a pre-charge period, a display period, and a discharge period, and the compensation signal is supplied from the pre-charge period.

22. The method of claim 14, wherein the scan lines comprise even scan lines and odd number scan lines, and the scan signal is alternatively supplied to the sub-pixels through an even scan line or an odd scan lines.
